(19) United States
(12) Patent Application Publication
(10) Pub. No.: US 2016/0140940 A1
(43) Pub. Date: May 19, 2016

(54) PERCUSSION, WIND AND RATTLING INSTRUMENT AND MUSICAL-INSTRUMENT ARRANGEMENT

(71) Applicant: Stephan SPRENGEL, 64289 Darmstadt (DE)

(72) Inventor: Stephan SPRENGEL, Darmstadt (DE)

(21) Appl. No.: 14/902,860

(22) PCT Filed: Apr. 10, 2014
(86) PCT No.: PCT/EP2014/057314

§ 371 Date: Jan. 25, 2016

(30) Foreign Application Priority Data
Jul. 5, 2013 (DE) 10 2013 107 082.5

(51) Int. Cl. G10D 15/00; G10D 13/02; G10D 7/00

(52) U.S. Cl. CPC G10D 15/00; G10D 7/00; G10D 13/02

(57) ABSTRACT

A percussion, wind and rattling instrument with a hollow resonating body is provided. The resonating body has a striking surface. A sound element is arranged within the resonating body. The resonating body has two sound holes. At least one sound hole has a diameter between 2 cm and 6 cm, preferably between 2.5 cm and 4.5 cm and particularly preferably between 3 cm and 4 cm. A musical-instrument arrangement having at least two percussion, wind and rattling instruments. The percussion, wind and rattling instruments are arranged adjacent to one another. In each case two sound holes of percussion, wind and rattling instruments arranged adjacent to one another border one another and form a sound channel.

### BACKGROUND AND SUMMARY

The invention relates, according to an aspect thereof, to a percussion, wind and rattling instrument with a hollow resonating body, a striking surface and a sound element, as well as a musical-instrument arrangement.

Percussion, wind and rattling instruments are already known. Percussion instruments usually comprise a resonating body having a striking surface, and are operated using drumsticks or the hands whereby a drum-like sound is generated.

Wind instruments usually comprise a resonance chamber through which, in contrast to a percussion instrument, a stream of air passes and generates a sound by turbulences. The pitch of the sound depends on the size of the resonance chamber and a direction of the airstream. Wind instruments are available in various formats and a variety of embodiments.

A rattling instrument, in contrast to the two musical-instruments already described above, comprises small sound elements which can be actuated by shaking movements and produce a sound. Also, different types of rattling instruments are available, wherein, according to the tonality desired, wood, metal or plastic materials are used as sound elements.

From DE 296 13 641 U1 a device for generating noises, especially a percussion/wind instrument in form of a toy figure, is known.

From the prior art, however, no musical-instruments are known which can be employed as percussion instrument, as wind instrument and as rattling instrument at the same time. Also, many of the known percussion instruments are considerably heavy and bulky such that they can not be played by children, for example.

Therefore, it is desirable to design a musical-instrument such that the said combines several musical-instruments into one, and can be handled simply and readily, even by children.

According to an aspect of the invention, a percussion, wind and rattling instrument is provided with a hollow resonating body, in which the resonating body has a striking surface, wherein a sound element is arranged within the resonating body, and wherein the resonating body has two sound holes. The striking surface of the resonating body is used for generating the drum-like sounds and forms a percussion instrument which has two sound holes. Said two sound holes, together with the resonating body, form a wind instrument, in which sounds are generated by an airstream between the sound holes. The airstream is produced by blowing into a sound hole of the percussion, wind and rattling instrument. A sound element positioned within the resonating body constitutes a rattling instrument by which sounds are generated as well, via shaking the resonating body. However, the sound element is also excited to oscillate by beating the striking surface and by blowing into a sound hole, such that a sound of the percussion, wind and rattling instrument is also determined by the sound element.

Regarding its dimensions, the resonating body is advantageously designed such that it can be conveniently held by hand and can be used as a wind instrument, portable percussion instrument or rattling instrument. Therein, the sound holes can be utilized for holding the percussion, wind and rattling instrument, and the said may readily also be used by children due to the handy dimensions of the resonating body.

By the combination of three musical-instruments into one percussion, wind and rattling instrument, the said musical-instrument offers various possibilities for the performance of music. Further, a transport of the instrument is facilitated due to the handy dimensions of the percussion, wind and rattling instrument.

The percussion, wind and rattling instrument can alternately be used as a percussion instrument, a wind instrument and a rattling instrument, or can be used simultaneously, for example, as percussion and wind instrument. For this purpose, the percussion, wind and rattling instrument can be beaten by one hand and simultaneously be blown through by one sound hole.

To be capable to readily blow the percussion, wind and rattling instrument by mouth, it is preferably provided that at least one sound hole of the percussion, wind and rattling instrument has a diameter between 2 cm and 6 cm, preferably between 2.5 cm and 4.5 cm and particularly preferably between 3 cm and 4 cm. While using the percussion, wind and rattling instrument as a wind instrument, the tones are generated by the exhaled air of a player, and therefore the size of at least one sound hole is advantageously designed such that the player can press the wind instrument against his or her mouth.

According to an embodiment of the inventive percussion, wind and rattling instrument, it is advantageously provided that at least one sound hole comprises an edge element made of soft rubber-like material, such as rubber, or soft plastic, disposed along its circumference. The soft rubber-like material around the sound hole prevents the player getting injured while pressing the sound hole against the player's mouth during the use of the percussion, wind and rattling instrument as a wind instrument. Further, the soft rubber-like material enables a simple sealing of the sound hole for enhancing the airstream through the resonating body while blowing into a sound hole.

Advantageously, it is provided according to an aspect of the invention that the sound holes are arranged at lateral faces of the resonating body adjacent to one another. When using the percussion, wind and rattling instrument as a rattling instrument, the sound holes located at the adjacent lateral faces are used for holding the rattling instrument. Hereby, a simpler handling of the rattling instrument is achieved. However, the sound holes can also be used as a holder in using the percussion, wind and rattling instrument as percussion instrument.

In a particularly advantageous design of the percussion, wind and rattling instrument, according to an aspect of the invention, it is provided that the resonating body is made from wood, plastic and/or metal. Due to a combination or a variation in the Materials of the body, the pitch of the percussion, wind and rattling instrument can be adapted to the respective purpose and to the desired pitch, respectively.

According to one embodiment of the inventive concept it is provided that the resonating body is designed in a cylindrical, pyramidal, cubic, cuboid, conical or spherical shape. The percussion, wind and rattling instrument can be designed in a variety of manners. By a change of the shape of the resonating body, the pitch of the percussion, wind and rattling instrument changes such that, by means of an adjustment of the shape of the resonating body, percussion, wind and rattling instruments having different sound characteristics can be manufactured. Moreover, the shape of the resonating body can be adapted for esthetical reasons or for facilitating the manageability.

According to an aspect of the invention it is provided that the sound element within the resonating body is arranged at an inner surface of the body. According to an aspect of the invention, the sound element, can also be loosely attached within the resonating body at two opposing inner surfaces whereby, in using the percussion, wind and rattling instrument as a rattling instrument, louder sounds can be generated.

In a particularly advantageous configuration of the inventive percussion, wind and rattling instrument, it is provided that the sound element is arranged within the resonating body at an inner surface of the striking surface. By arranging the sound element at the inner surface of the striking surface, while using the percussion, wind and rattling instrument as a percussion instrument, for example, a jarring effect can be achieved by a snare carpet which essentially comprises a series of wires spanned in parallel.

Advantageously, it is provided that the sound element comprises several sound members, mounted in a slightly damped manner. By a strike on the striking surface or by a shaking motion of a player, the sound members are excited to oscillate and generate sounds of various tone pitch by collisions against each other. A slight damping of the sound members effects a sufficiently rapid abatement of the generated sounds such that the sound members can be excited sufficiently quick for the generation of the next sound.

In a particularly advantageous embodiment of the inventive percussion, wind and rattling instrument, it is provided that the sound members are designed in a rod and/or wire-like shape. For example, the sound members can be designed in the shape of a carpet having adjoining metal helices to generate a snare-effect while using the percussion, wind and rattling instrument as a percussion instrument. For producing a crunching sound, the sound element can be designed in the shape of a broom having several rod-like sound members. The broom may be secured at a linked end to the inner surface of the resonating body, while the free-swinging end of the broom serves to generate the sounds.

According to an aspect of the invention, it is advantageously provided that the sound members are made from metal, wood and/or plastic material. Sound members made of a metal provide a stronger sound than sound members made of a plastic or a wood. By a combination of different materials, a desired tone pitch and a desired sound of the percussion, wind and rattling instrument can be achieved.

To influence the sound of the percussion, wind and rattling instrument, according to an aspect of the invention, it is provided that a sound conducting element is arranged within the resonating body and is secured at the inner surface of the resonating body such that an interior space of the resonating body is subdivided into at least two areas separated from each other. In this manner, for example, a sound volume can be reduced in which the generated sound within the interior can propagate unimpededly. In this manner, especially with a percussion, wind and rattling instrument from plastic, a fuller sound of the instrument can be achieved during the use as a wind instrument.

To influence the acoustic properties of the percussion, wind and rattling instrument by a sound conducting element during use of the instrument as percussion instrument positively, it is advantageously contemplated that the sound conducting element forms a conducting channel starting from a side of the sound conducting element which faces to the striking surface, extending towards a lateral surface of the resonating body which lies opposed to the striking surface, wherein the side of the sound conducting element which faces to the striking surface is spaced apart from the striking surface. In this manner, the sound arising upon beating onto the striking surface is able to propagate unimpededly towards the opposing lateral surface.

In a especially advantageous embodiment of the inventive percussion, wind and rattling instrument it is contemplated that the sound conducting element, at the side facing to the striking surface, has a disc-shaped conductive surface, wherein the conductive surface fits closely along a circumference at the inner surface of the resonating body, and that the conductive surface, in a central portion, merges into the conducting channel, wherein the conducting channel ends at lateral surface of the body which lies opposed to the striking surface. In this manner, both, the sound of the instrument during use as a wind instrument as well during use as a percussion instrument can be influenced in a particularly effective way such that the instrument is provided with the desired acoustic properties.

In case the percussion, wind and rattling instrument having a sound conducting element is used as a rattling instrument, the rattling characteristic of the instrument according to an aspect of the invention can be influenced in that a rattling element is arranged, freely movable, within a sound area formed by the sound conducting element and the inner surface of the resonating body. According to an aspect of the invention, the rattling element can be e.g. metal beads or the like.

The invention also relates, according to an aspect thereof, to a musical-instrument arrangement having at least two percussion, wind and rattling instruments as described above, wherein the percussion, wind and rattling instruments are arranged adjacent to one another, and in each case two sound holes of percussion, wind and rattling instruments arranged adjacent to one another border one another and form a sound channel. By an arrangement of the percussion, wind and rattling instruments adjacent to one another, for example, by stacking on top of each other or by juxtaposing, an extension of the volume of the resonating body is achieved, and the pitch of the musical-instrument, arrangement differs from the pitch of a single percussion, wind and rattling instrument. The modular design of the inventive musical-instrument arrangement, further, allows a simple assembly and disassembly of the musical-instrument arrangement, and a transport of the musical-instrument arrangement can be carried out in an easier way.

According to an aspect of the invention, it is advantageous that sound holes of percussion, wind and rattling instruments arranged adjacent to one another, which holes contact each other and form a sound channel, have the same diameter. Due to the identical diameter of the percussion, wind and rattling instruments arranged adjacent to one another, it is achieved that the sound channel has a defined diameter and the musical-instrument arrangement exhibits identical sound properties after disassembly and renewed assembly.

According to an aspect of the invention it is advantageously provided that the musical-instrument arrangement comprises fastener means, wherein percussion, wind and rattling instruments arranged adjacent to one another having sound holes, which contact each other and form a sound channel, are joined together reversibly by the fastener means. The fastener means prevent a slippage of the percussion, wind and rattling instruments arranged adjacent to one another, and, further, any alteration of the diameter of the sound channel and of the pitch of the musical-instrument arrangement resulting therefrom. According to an aspect of the invention, the fastener means can be configured in form of a clamp which joins the lateral surfaces of two percussion, wind and rattling instruments arranged adjacent to one another. However, it is also possible and advantageously provided that the percussion, wind and rattling instruments, along a circumference of the sound holes, each have a groove which can be connected to one another by an external spring.

Further advantageous designs of the inventive percussion, wind and rattling instrument are illustrated in more detail by the embodiments illustrated in the drawing.

### BRIEF DESCRIPTION OF THE DRAWINGS

The figures show in

FIG. 1 a schematic illustration of a percussion, wind and rattling instrument having two sound holes,

FIG. 2 a schematic illustration of a percussion, wind and rattling instrument with the edges cut open,

FIG. 3 a schematic illustration of a percussion, wind and rattling instrument in form of a truncated icosahedron,

FIG. 4 a schematic view of a musical-instrument arrangement comprising three percussion, wind and rattling instruments,

FIG. 5 a schematic sectional view of the musical-instrument arrangement illustrated in FIG. 4,

FIG. 6 a schematic view of two percussion, wind and rattling, instruments which are connected to each other by a groove into a musical-instrument arrangement,

FIG. 7 a schematically illustrated partial sectional view of a percussion, wind and rattling instrument having a sound conducting element.

### DETAILED DESCRIPTION

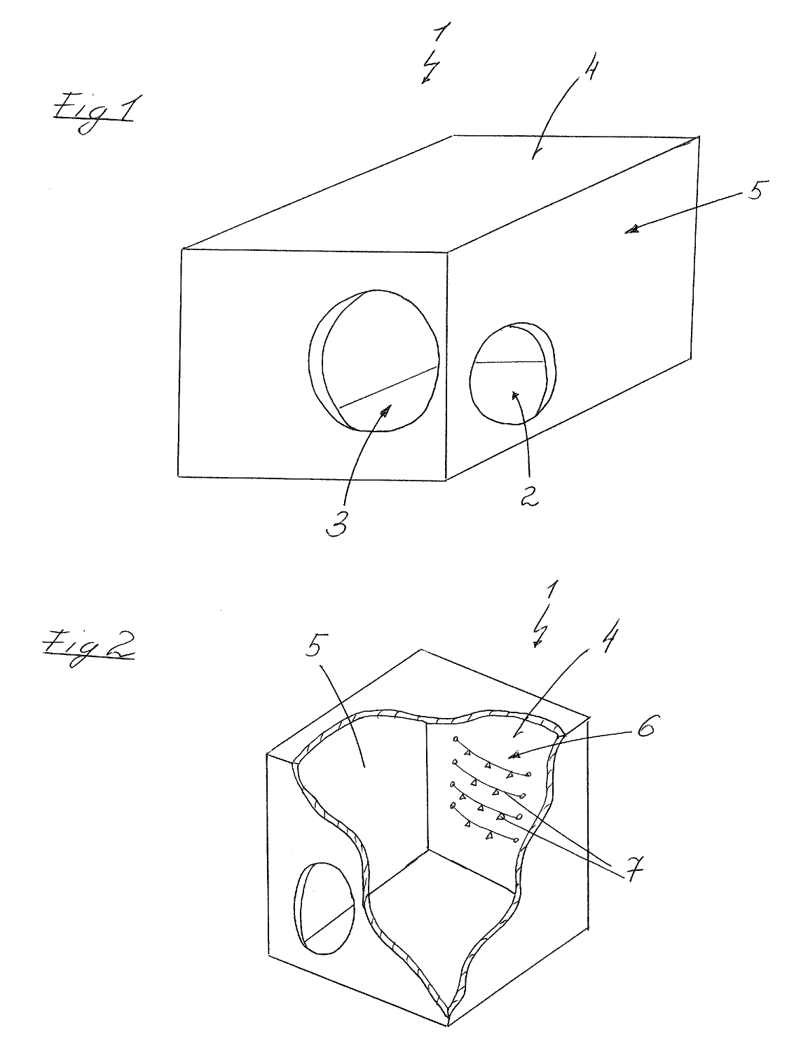

In FIG. 1, a cuboid percussion, wind and rattling instrument 1 having two sound holes 2 and 3 arranged at adjacent lateral surfaces is shown. The dimensions of the percussion, wind and rattling instrument 1 in this exemplary embodiment are approximately 14 cm×11 cm×6 cm, and the percussion, wind and rattling instrument 1 can readily be used as a wind or a rattling instrument. The sound hole 2 has a diameter of less than 6 cm and can be used as an inlet opening for blowing the instrument 1. The sound hole 3 has a larger diameter than the sound hole 2, and can be used as the outlet opening if the percussion, wind and rattling instrument 1 is used as wind instrument. One of the lateral faces of the percussion, wind and rattling instrument 1 forms a striking surface 4, at which inside the resonating body 5, a sound element 6 (not shown) is attached. The sound holes 2 and 3 are arranged at adjacent lateral surfaces such that they may be used as a holder for the percussion, wind and rattling instrument 1. The percussion, wind and rattling instrument 1 also can have different dimensions such as, for example, 14 cm×14 cm×7 cm or 11 cm×11 cm×11 cm.

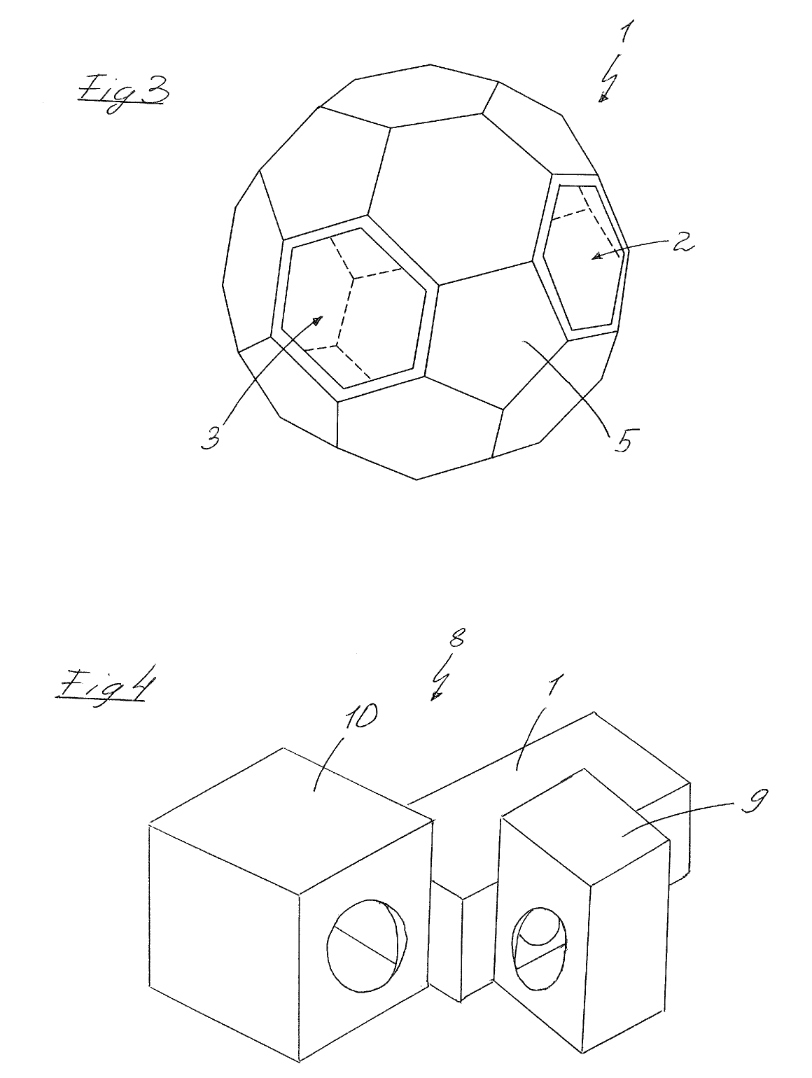

FIG. 2 shows a perspective illustration of a percussion, wind and rattling instrument 1 with the lateral surfaces cut open, such that the sound element 6 is visible. The sound element 6 is positioned within the percussion, wind and rattling instrument 1 on an inner side of the striking surface 4 within the resonating body 5. The sound element 6 comprises multiple sound members 7 which generate the sounds during the use of the musical instrument 1 as percussion and/or rattling instrument. The sound members 7 are mounted in a slightly damped manner at the inner side of the striking surface 4 of the resonating body 5 such that abatement of the generated sound is possible.

In FIG. 3, a percussion, wind and rattling instrument 1 having a resonating body 5 in form of a truncated icosahedron, is shown. In this exemplary embodiment, the sound holes 2 and 3 are shaped identically, in a hexagonal manner. The sound element 6 (not shown) in this exemplary embodiment can be attached at two opposing lateral faces within the resonating body 5.

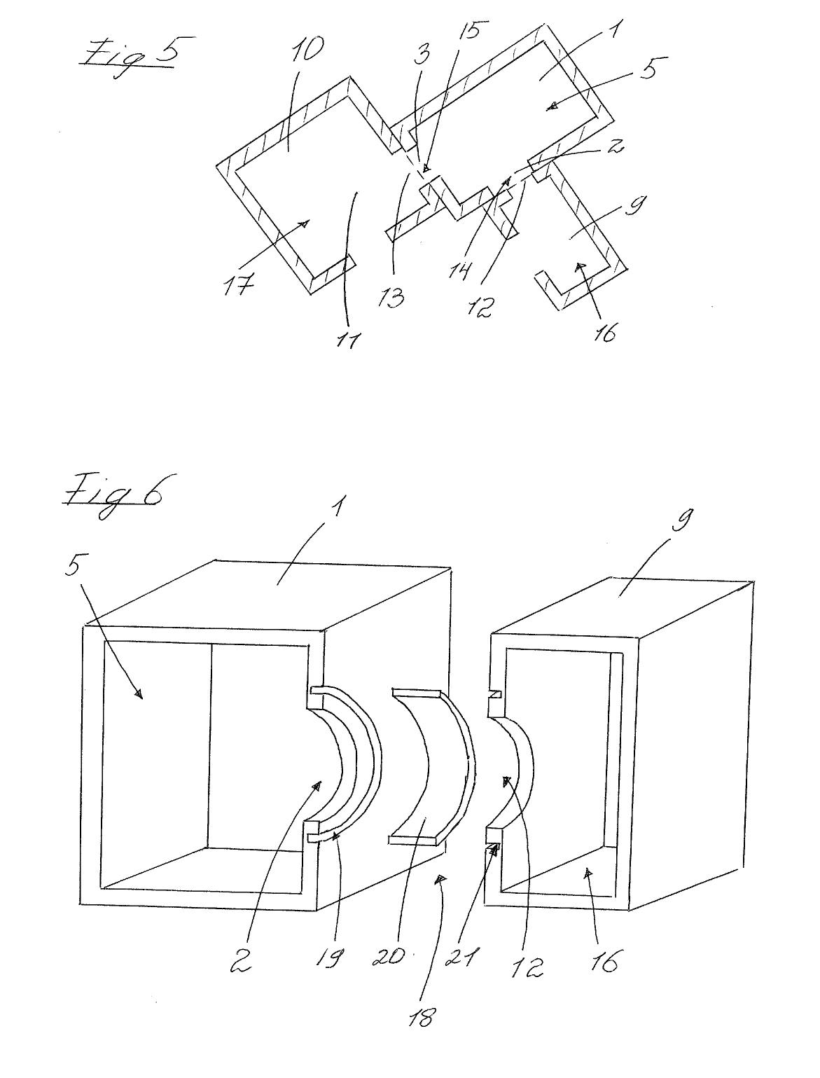

FIG. 4 shows a musical-instrument arrangement 8 comprising three percussion, wind and rattling instruments 1, 9 and 10 which have a cuboid shape. In FIG. 5, a sectional view of the musical-instrument arrangement 8 is illustrated. The percussion, wind and rattling instruments 1, 9 and 10 are arranged adjacent to one another and form an extended resonating body 11. The sound holes 2 and 12 as well as 3 and 13, which lie contacting each other, form the sound channels 14 and 15. Via the sound channels 14 and 15, the resonating bodies 5, 16 and 17 of the percussion, wind and rattling instruments 1, 9 and 10 are merged into the extended resonating body 11. The musical-instrument arrangement 8 can be redesigned by rearrangement of the percussion, wind and rattling instruments 1, 9 and 10 and easily be assembled and disassembled for transport.

The percussion, wind and rattling instruments 1, 9 and 10 of the musical-instrument arrangement 8 can be joined together by fastening means such that a slippage of the percussion, wind and rattling instruments 1, 9 and 10 arranged adjacent to one another, due to the forces acting onto the lateral faces of the resonating body 5 and 16 by a player, is avoided. In this manner, a change of a diameter of the sound channel 14 and thus a change of the pitch of the musical-instrument arrangement 8 is effectively avoided.

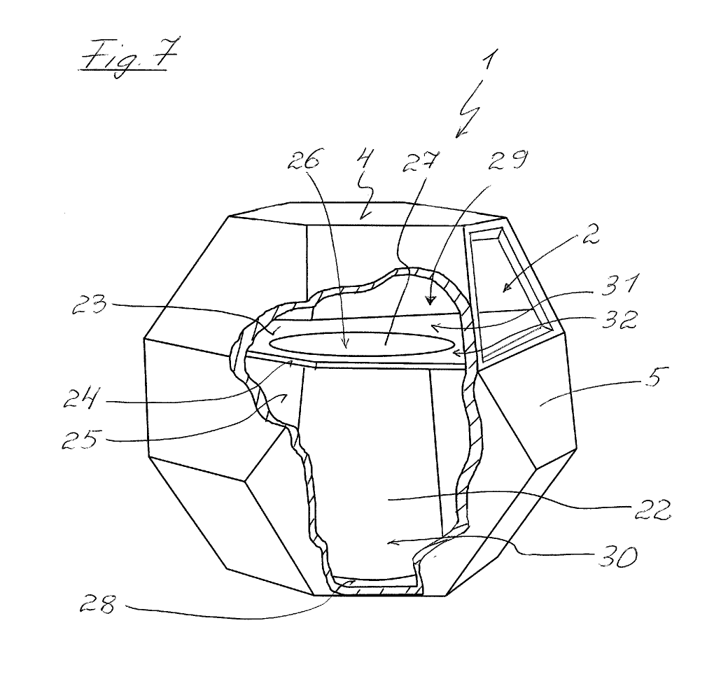

In FIG. 6, fastening means 18 in form of a groove 19 along the circumference of sound hole 2 and a groove 21 along the circumference of sound hole 12, and an external spring 20 are shown. The grooves 19 and 21 and the spring 20 are manufactured in positively locking manner. and effect a clamping connection of two percussion, wind and rattling instruments 1 and 9 arranged adjacent to one another. The spring 20 has a width adapted to the depth of the grooves 19 and 21 such that the lateral faces of the percussion, wind and rattling instruments 1 and 9 arranged adjacent to one another are joined together bordering each other.

FIG. 7 shows a schematically illustrated partial sectional view of a percussion, wind and rattling instrument 1 having a sound conducting element 22 arranged within a resonating body 5. The sound conducting element 22, at a side facing to the striking surface 4, has a disc-shaped conductive surface 23. The conductive surface 23 tits closely along a circumference 24 at an inner surface 25 of the resonating body 5. In a central portion 26, the conductive surface 23 merges into a conducting channel 27. The conducting channel 27 ends at a lateral surface 28 of the resonating body 5 which lies opposed to the striking surface 4, such that a sound generated upon beating onto the striking surface 4 can propagate from the striking surface 4 to the lateral surface 28 unimpededly. By means of the sound conducting element 22, an inner space 29 of the resonating body 5 is subdivided into two portions 30 and 31 separated from each other. Within a sound volume 32 which is formed by the portion 31, a rattling element may be arranged in a freely movable manner, whereby a supplementary rattling noise can be generated.

1. Percussion, wind and rattling instrument with a hollow resonating body, wherein the resonating body has a striking surface, wherein a sound element is arranged within the resonating body, and wherein the resonating body has two sound holes.

2. Percussion, wind and rattling instrument according to claim 1, wherein at least one sound hole has a diameter between 2 cm and 6 cm, preferably between 2.5 cm and 4.5 cm, and particularly preferably between 3 cm and 4 cm.

3. Percussion, wind and rattling instrument according to claim 1, wherein at least one sound hole has an edge element made of a soft rubber-like material disposed along its circumference.

4. Percussion, wind and rattling instrument according to claim 1, wherein the sound holes are arranged at lateral surfaces of the resonating body adjacent to one another.

5. Percussion, wind and rattling instrument according to claim 1, wherein the resonating body is made from wood, plastic and/or metal.

6. Percussion, wind and rattling instrument according to claim 1, wherein the resonating body is designed in a cylindrical, pyramidal cubic, cuboid, conical or spherical shape.

7. Percussion, wind and rattling instrument according to claim 1, wherein the sound element within the resonating body is arranged at an inner surface of the resonating body.

8. Percussion, wind and rattling instrument according to claim 7, wherein the sound element within the resonating body is arranged at an inner surface of the striking surface.

9. Percussion, wind and rattling instrument according to claim 1, wherein the sound element comprises several sound members mounted in a slightly damped manner.

10. Percussion, wind and rattling instrument according to claim 9, wherein the sound members of the sound element are designed in a rod and or wire-like shape.

11. Percussion, wind and rattling instrument according to claim 9, wherein the sound members of the sound element are fabricated from metal, wood and/or plastic material.

12. Percussion, wind and rattling instrument 44 according to claim 1, wherein within the resonating body a sound conducting element is arranged and is secured at the inner surface of the resonating body such that an interior space of the resonating body is subdivided into at least two portions separated from each other.

13. Percussion, wind and rattling instrument according to claim 12, wherein the sound conducting element forms a conducting channel starting from a side of the sound conducting element which faces the striking surface, extending towards a lateral surface of the resonating body which lies opposed to the striking surface, wherein the side of the sound conducting element which faces to the striking surface is arranged spaced apart from the striking surface.

14. Percussion, wind and rattling instrument according to claim 13, wherein the sound conducting element, at the side facing to the striking surface, comprises a disc-shaped conductive surface, wherein the conductive surface fits closely along a circumference at the inner surface of the resonating body, and that the conductive surface, in a central portion, merges into the conducting channel, wherein the conducting channel ends at the lateral surface of the resonating body which lies opposed to the striking surface.

15. Percussion, wind and rattling instrument according to claim 14, wherein a rattling element is arranged freely movable within a sound volume formed by the sound conducting element and the inner surface of the resonating body.

16. Musical-instrument arrangement having at least two percussion, wind and rattling instruments according to claim 1, wherein the percussion, wind and rattling instruments are arranged adjacent to one another, and wherein in each case two sound holes of percussion, wind and rattling instruments arranged adjacent to one another border one another and form a sound channel.

17. Musical-instrument arrangement according to claim 16, wherein sound holes of percussion, wind and rattling instruments arranged adjacent to one another, which holes contact one another at form a sound channel, have the same diameter.

18. Musical-instrument arrangement according to claim 16, wherein the musical-instrument arrangement comprises fastening means, wherein percussion, wind and rattling instruments arranged adjacent to one another having sound holes which contact one another and form a sound channel, are joined together reversibly by the fastening means.
